(19) United States
(12) Patent Application Publication
(10) Pub. No.: US 2011/0251877 A1
(43) Pub. Date: Oct. 13, 2011

(54) MODEL FOR MARKET IMPACT ANALYSIS OF PART REMOVAL FROM COMPLEX PRODUCTS

(75) Inventors: Richard D. Lawrence, Ridgefield, CT (US); Claudia Perlich, Mount Kisco, NY (US)

(73) Assignee: INTERNATIONAL BUSINESS MACHINES CORPORATION, Armonk, NY (US)

(21) Appl. No.: 12/755,836

(22) Filed: Apr. 7, 2010

(51) Int. Cl. G06Q 10/00; G06Q 90/00; G06F 17/30

(52) U.S. Cl. 705/7.37; 707/790; 707/E17.079; 705/302; 705/7.38

(57) ABSTRACT

A model for impact analysis determines impact of part removal from a product. An entity is identifies that includes a plurality of sub-components. One or more performance measures associated with the entity are identified. One or more of the sub-components to be removed from the entity are identified. A substitution impact function is defined. Impact on said one or more performance measures is determined using the substitution impact function.

### FIELD

The present application is generally related to analyzing market impact of part removal from products.

### BACKGROUND

Complex configurable products such as computers are constructed from multiple components. There are times, however, when not all the components that make up the product are available. In such cases, the products should still be provided with those omitted components or substituted components to replace those omitted components. Furthermore, it may not be economical to maintain an inventory of a large number of different components to satisfy all possible products. In order to make decisions on which components to eliminate from future offerings, manufacturers need a quantitative methodology to assess the impact of the removal of specific components on the overall market performance of the product set. The present application discloses analyzing the impact of part removal from complex products.

### BRIEF SUMMARY

A method for determining impact of part removal from a product, in one aspect, may include identifying an entity that includes a plurality of sub-components and identifying one or more performance measures associated with the entity. The method further may include identifying one or more of the sub-components to be removed from the entity. The method also may include defining a substitution impact function, and aggregating impact on said one or more performance measures using the substitution impact function.

A system for determining impact of part removal from a product, in one aspect, may include a database storing information associated with identifying an entity that includes a plurality of sub-components, one or more performance measures associated with the entity, and identifying one or more of the sub-components to be removed from the entity. A module may be operable to aggregate impact on said one or more performance measures using a substitution impact function.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a method of evaluating component removal in one embodiment of the present disclosure.

FIG. 2 is an architectural diagram illustrating functional components for a system that evaluates component removal in one embodiment of the present disclosure.

FIG. 3 illustrates an example of a computer system, in which the systems and methodologies of the present disclosure may be carried out or executed.

### DETAILED DESCRIPTION

An impact of removal of components may be estimated based on the expected revenue shortfall from past revenue observations by making reasonable assumptions about the willingness of a customer to buy an alternative version of a product.

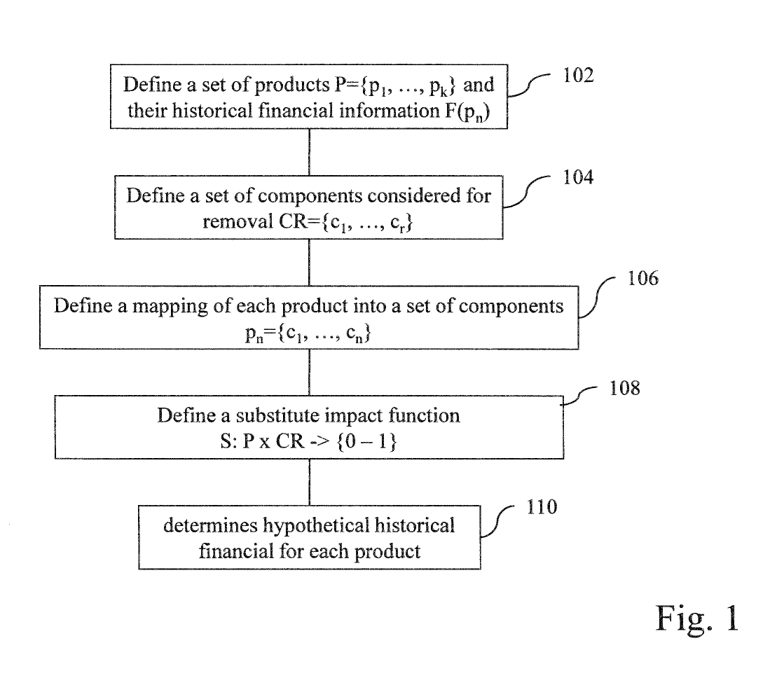

FIG. 1 is a flow diagram illustrating a method of evaluating component removal in one embodiment of the present disclosure. At 102, a set of products P={p₁, . . . , pₖ} and their historical financial information F(pₙ) is defined. This may include identifying a complex entity or product that is composed of sub components, and identifying a single or set of relevant performance measures on the complex entity. An example of a set P of products is a set of k models of laptops. Each model has a different configuration and, as a result, is composed by a number of specific components. The financial information F of a model could be the total revenue generated through the sales of all laptops of this model and is historically observed and saved for instance in a database. At 104, a set of components considered for removal CR={c₁, . . . , Cᵣ} is defined. At 106, a mapping of each product into a set of components pₙ={c₁, . . . , cₙ} is defined. At 108, a substitute impact function S: P×CR->{0−1} is defined. This impact captures the extent to which a product p₁ is still functional and/or can be sold if the components in CR are not longer available and the components would have to be removed from the product p or substituted by an alternative component that is not element of CR. For example, one may consider removing a specific processor (1.8 GHz) from the list of available components and selling all laptops that used the component in their configuration with an alternative processor (2.0 GHz).

At 110, a model determines hypothetical historical financial for each product: F′(pₙ)=F(pₙ)*S(pₙ, CR). The new outcome, i.e., the impact is a function of the historical financial information F(pₙ) and the substitute factor S(pₙ, CR), e.g., an aggregation of the impact on the relevant performance measures from the complex entities based on historical transactions.

The substitute factor S for product pₙ with CR component removed, i.e., substitute factor S(pₙ, CR)=1 where there is a perfect substitution with no impact. A perfect dependence of pₙ on the component CR would result in S being 0, i.e., S(pₙ, CR)=0. For those cases where the dependence is between the perfect substitution and perfect dependence, the substitute impact may be computed as the probability of purchase of alternative machine and may be proportional to the percentage of missing and/or replaced components. That is:

$$S ( {p}_{n} , CR ) = \frac{\vert {p}_{n} \vert - \vert CR ⋂ {p}_{n} \vert}{\vert {p}_{n} \vert}$$

where ∥ denotes the size of the set. Thus, for example, the effect of eliminating feature or element C from a product that is originally made up of components {A, B, C, D, E, F, G} may be that a customer may accept an alternative product made up of components {A, B, *, D, E, F, G} where ‘*’ represents a substitute component, with probability of 6/7=0.85 or 85%. A more complex instantiation could include in addition a specific components based estimate of substitutability: SC: CR->[0,1]. For instance, a particular processor (1.8G) is fully substitutable by its next generation 2.0G. Now we have

$$S ( {p}_{n} , CR ) = {\prod }_{c ∈ \{ CR ⋃ {p}_{n} \}} SC ( c )$$

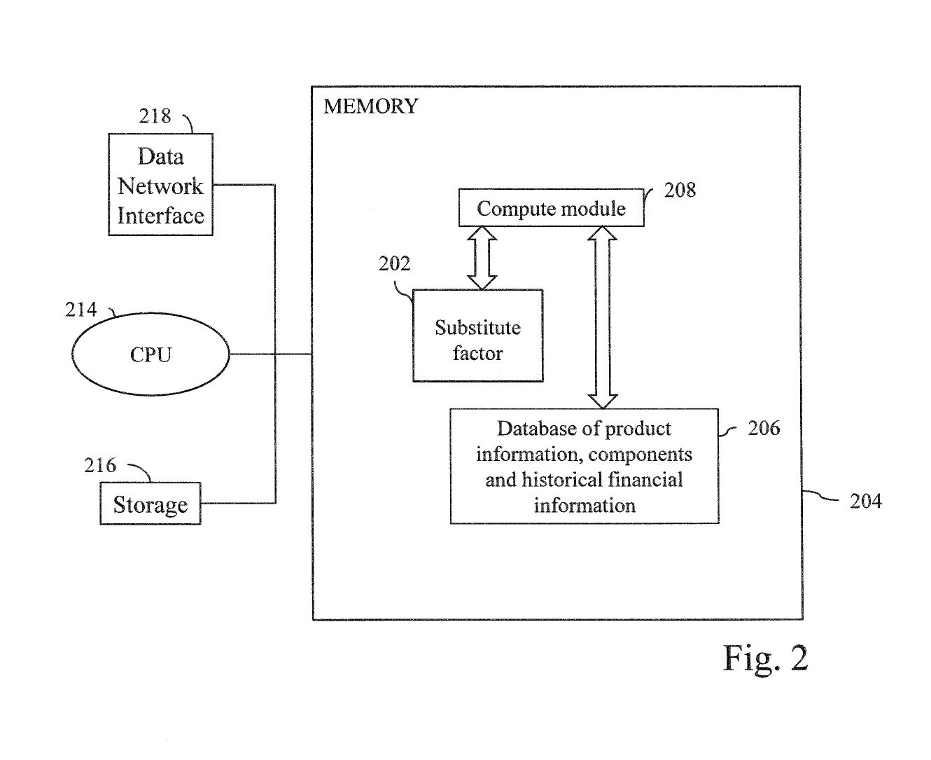

FIG. 2 is an architectural diagram illustrating functional components for a system that evaluates component removal in one embodiment of the present disclosure. FIG. 2 illustrates a system for determining impact of part removal from complex products and its functional components in one embodiment. The modules shown in FIG. 2 may be components of a computer system that may include any computing node that is able to load and execute programmatic code, for instance, running the operating system and server application suite. The system logic may be embodied as computer executable code that is loaded from a remote source (e.g., from a network file system), local permanent optical (CD-ROM), magnetic storage (such as disk), or storage 216 into memory 204 for execution by CPU 214. A network interface 218 may be used for communicating to other network accessible services. Such an interface 218 may include, but is not limited to a hardwired device, e.g., Ethernet over coax cable, wireless IP, and telephone to IP (VoIP), or others. The memory 204 may include computer readable instructions, data structures, program modules and application interfaces providing logic or functional components for impact analysis of part removal from complex products.

It should be understood that while FIG. 2 illustrates the functional components residing in a computer system, the system and method of the present disclosure is not limited to only that configuration. Thus, the components may be distributed over a network on different platforms in a distributed environment, and/or configured in a cloud computing environment. Further, while FIG. 2 shows a CPU 214, the system may include multiple processors and/or cores.

A compute module 208 may take inputs such as the set of products and their historical financial information, components considered for removal, mapping of each product into a set of components may be retrieved from a database of information 206 and also a substitute function 202, and determine or predict an impact of removing a component from a complex product.

The model and/or algorithm disclosed herein may be utilized, for example, for estimating product revenue or profit shortfall or other market impact under part removal for a physical product such as a computer or an automobile. Another example for which the model and/or algorithm disclosed herein may be used may be estimation of revenue or profit shortfall over all shopping baskets (a “product” in previous terminology) in a retail store if a specific component is removed from the store inventory.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

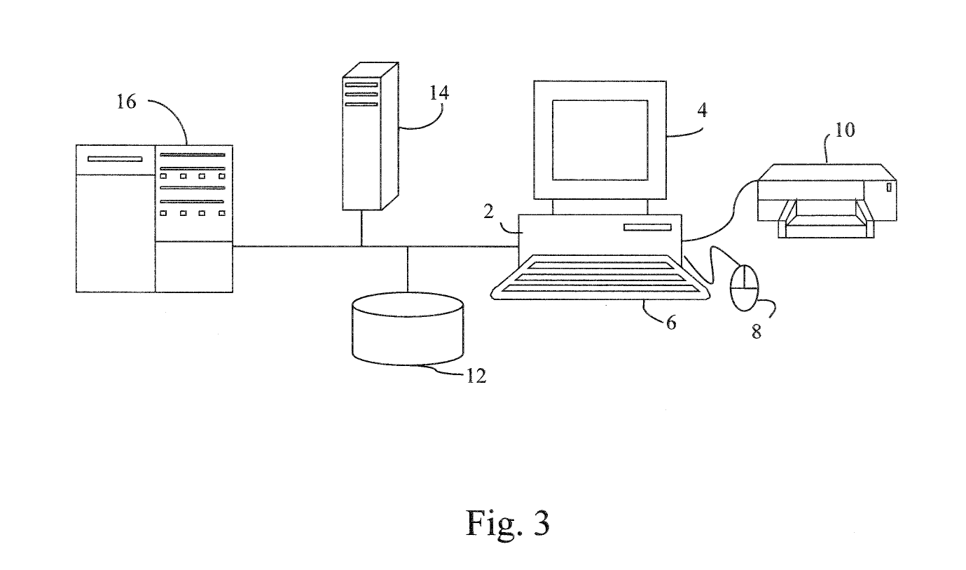

Referring now to FIG. 3, the systems and methodologies of the present disclosure may be carried out or executed in a computer system that includes a processing unit 2, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit 2 by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen 4 for presenting output displays and providing a display through which the user may input data and interact with the processing system, for instance, in cooperation with input devices such as the keyboard 6 and mouse device 8 or pointing device. The computer processing system may be also connected or coupled to one or more peripheral devices such as the printer 10, scanner (not shown), speaker, and any other devices, directly or via remote connections. The computer processing system may be connected or coupled to one or more other processing systems such as a server 10, other remote computer processing system 14, network storage devices 12, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 2, 14, 16), or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for determining impact of part removal from a product, comprising:
identifying an entity that includes a plurality of sub-components;
identifying one or more performance measures associated with the entity;
identifying one or more of the sub-components to be removed from the entity;
defining a substitution impact function; and
aggregating impact on said one or more performance measures using the substitution impact function.

2. The method of claim 1, wherein the substitute function is defined as 1 if a substitute component replacing a removed component is completely interchangeable.

3. The method of claim 1, wherein the substitute function is defined as 0 if the entity completely depends on a removed component.

4. The method of claim 1, wherein the substitute function is defined as a probability function.

5. The method of claim 1, wherein the entity is a product.

6. The method of claim 1, wherein the entity is an organization.

7. A system for determining impact of part removal from a product, comprising:
a processor;
a database storing information associated with identifying an entity that includes a plurality of sub-components, one or more performance measures associated with the entity, and identifying one or more of the sub-components to be removed from the entity;
a substitution impact function; and
a module operable to aggregate impact on said one or more performance measures using the substitution impact function.

8. The system of claim 7, wherein the substitute function is defined as 1 if a substitute component replacing a removed component is completely interchangeable.

9. The system of claim 7, wherein the substitute function is defined as 0 if the entity completely depends on a removed component.

10. The system of claim 7, wherein the substitute function is defined as a probability function.

11. The system of claim 7, wherein the entity is a product.

12. The system of claim 7, wherein the entity is an organization.

13. A computer readable storage medium storing a program of instructions executable by a machine to perform a method of determining impact of part removal from a product, comprising:
identifying an entity that includes a plurality of sub-components;
identifying one or more performance measures associated with the entity;
identifying one or more of the sub-components to be removed from the entity;
defining a substitution impact function; and
aggregating impact on said one or more performance measures using the substitution impact function.

14. The computer readable storage medium of claim 13, wherein the substitute function is defined as 1 if a substitute component replacing a removed component is completely interchangeable.

15. The computer readable storage medium of claim 13, wherein the substitute function is defined as 0 if the entity completely depends on a removed component.

16. The computer readable storage medium of claim 13, wherein the substitute function is defined as a probability function.

17. The computer readable storage medium of claim 13, wherein the entity is a product.

18. The computer readable storage medium of claim 13, wherein the entity is an organization.
